(19) United States
(12) Patent Application Publication
(10) Pub. No.: US 2025/0334963 A1
(43) Pub. Date: Oct. 30, 2025

(54) GENERATIVE AI CUSTOMER SUPPORT ACCELERATOR

(71) Applicant: Rockwell Automation Technologies, Inc., Mayfield Heights, OH (US)

(72) Inventors: Francisco P Maturana, Lyndhurst, OH (US); Meiling He, Milwaukee, WI (US); Patrick Dey, Ladera Ranch, CA (US); Christopher Nardecchia, Westlake Village, CA (US); Jonathan A. Mills, Mayfield Heights, OH (US)

(21) Appl. No.: 18/645,628

(22) Filed: Apr. 25, 2024

(51) Int. Cl. G05B 23/02

(52) U.S. Cl. CPC G05B 23/0272; G05B 23/0229; G05B 23/0281

(57) ABSTRACT

An industrial technical support system leverages generative artificial intelligence (AI) techniques to generate technical support guidance and recommendations in response to natural language technical support requests submitted as natural language input. The system can maintain and leverage one or more sets of custom models trained with sets of domain-specific training data specific for different industrial domains. When a natural language technical support query is received, the system leverages the domain-specific training data as well as responses prompted form a generative AI model to formulate and render technical support recommendations for addressing a performance or design issue described by the query.

### TECHNICAL FIELD

The subject matter disclosed herein relates generally to industrial automation systems, and, for example, to provision of technical support guidance for addressing industrial performance issues.

### BACKGROUND ART

Maintenance and troubleshooting of a plant's industrial control systems and their associated machines and devices are typically carried out by on-site service engineers or machine operators. While some types of routine machine alarm or fault conditions can be easily addressed, unfamiliar alarm conditions or system performance issues require the service personnel to expend considerable time and effort finding resolutions to the problems. These resolution efforts can include referencing device or software manuals or contacting a vendor's customer support personnel for assistance in diagnosing and resolving the condition.

The above-described deficiencies of current approaches to resolving industrial alarm conditions and performance issues are merely intended to provide an overview of some of the problems of current technology, and are not intended to be exhaustive. Other problems with the state of the art, and corresponding benefits of some of the various non-limiting embodiments described herein, may become further apparent upon review of the following detailed description.

### BRIEF DESCRIPTION

The following presents a simplified summary in order to provide a basic understanding of some aspects described herein. This summary is not an extensive overview nor is it intended to identify key/critical elements or to delineate the scope of the various aspects described herein. Its sole purpose is to present some concepts in a simplified form as a prelude to the more detailed description that is presented later.

In one or more embodiments, a system is provided, comprising a user interface component configured to receive, from a client device as natural language input, a query describing a performance issue relating to an industrial automation system for which technical support is requested; and a generative artificial intelligence (AI) component configured to, in response to receipt of the query, formulate a prompt, directed to a generative AI model, designed to obtain a response from the generative AI model comprising information used by the generative AI component to generate a natural language technical support response describing a recommendation for addressing the performance issue, wherein the generative AI component generates the prompt based on analysis of the query and a selected subset of industrial training data encoded in one or more custom models, wherein the user interface component is configured to render the natural language technical support response on the client device.

Also, one or more embodiments provide a method, comprising receiving, by a system comprising a processor from a client device, a query formatted as a natural language input, wherein the query describes a performance issue relating to an industrial automation system for which technical support is requested; in response to the receiving, formulating, by the system based on analysis of the query and a selected subset of industrial training data encoded in one or more custom models, a prompt directed to a generative artificial intelligence (AI) model, wherein the prompt is formulated to obtain a response from the generative AI model comprising information used by the system to generate a natural language technical support response describing a recommendation for addressing the performance issue; and rendering, by the system, the natural language technical support response on the client device.

Also, according to one or more embodiments, a non-transitory computer-readable medium is provided having stored thereon instructions that, in response to execution, cause a system to perform operations, the operations comprising receiving, from a client device, a query formatted as a natural language input, wherein the query describes a performance issue relating to an industrial automation system for which technical support is requested; in response to the receiving, formulating, based on analysis of the query and a selected subset of industrial training data encoded in one or more custom models, a prompt directed to a generative artificial intelligence (AI) model, wherein the prompt is formulated to obtain a response from the generative AI model comprising information used by the system to generate a natural language technical support response describing a recommendation for addressing the performance issue; and rendering, by the system, the natural language technical support response on the client device.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of an example industrial technical support system.

FIG. 3 is a diagram illustrating an example architecture of the industrial technical support system.

FIG. 4 is a diagram illustrating training of custom models used by a generative AI component.

FIG. 5 is a diagram illustrating creation and submission of a prompt to a generative AI model in response to receipt of a natural language technical support query from a user.

FIG. 6 is a diagram illustrating formulation and delivery of a response to a user's natural language query.

FIG. 7 is an example chatbot window that can be used to interact with the technical support system.

FIG. 8 is a diagram illustrating delivery of the technical support system's response and updating of the custom models.

FIG. 9 is a diagram illustrating an example architecture in which the technical support system maintains separate sets of custom models associated with respective different industrial domains.

FIG. 10a is a flowchart of a first part of an example methodology for using generative AI to provide technical guidance for resolving automation system performance problems or alarm conditions observed on industrial assets.

FIG. 10b is a flowchart of a second part of the example methodology for using generative AI to provide technical guidance for resolving automation system performance problems or alarm conditions observed on industrial assets.

FIG. 11 is an example computing environment.

FIG. 12 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

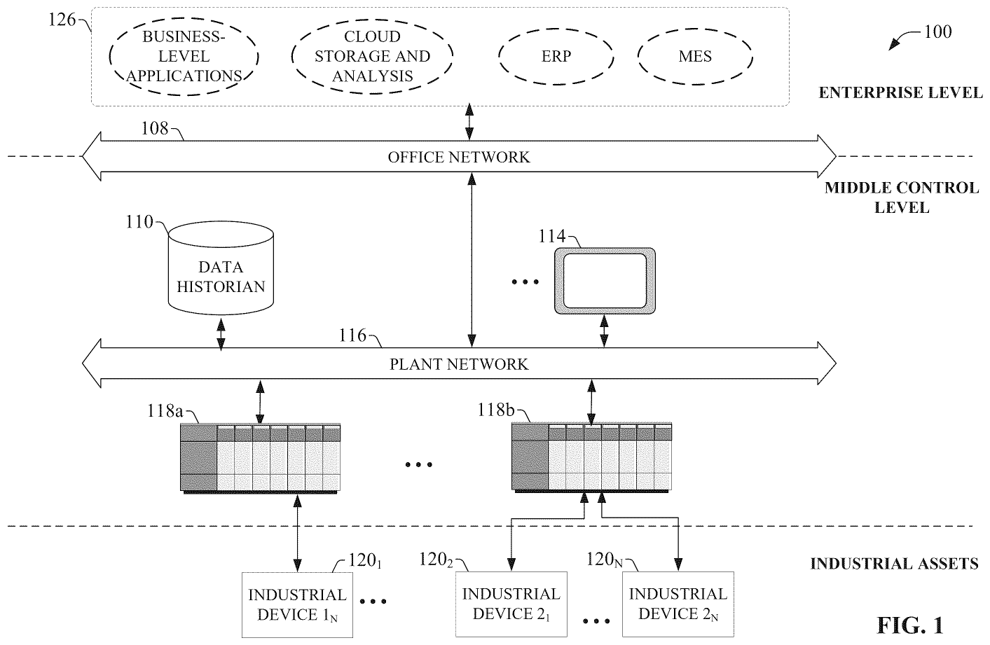

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise substantially any type of control code capable of processing input signals read from the industrial devices 120 and controlling output signals generated by the industrial controllers 118, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), present sensing devices (e.g., inductive or capacitive proximity sensors, photoelectric sensors, ultrasonic sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot controllers, valves, pumps, and the like.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over a network using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by their associated control programs and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, a data historian 110 that aggregates and stores production information collected from the industrial controllers 118 or other data sources, device documentation stores containing electronic documentation for the various industrial devices making up the controlled industrial systems, inventory tracking systems, work order management systems, repositories for machine or process drawings and documentation, vendor product documentation storage, vendor knowledgebases, internal knowledgebases, work scheduling applications, or other such systems, some or all of which may reside on an office network 108 of the industrial environment.

Higher-level systems 126 may carry out functions that are less directly related to control of the industrial automation systems on the plant floor, and instead are directed to long term planning, high-level supervisory control, analytics, reporting, or other such high-level functions. These systems 126 may reside on the office network 108 at an external location relative to the plant facility, or on a cloud platform with access to the office and/or plant networks. Higher-level systems 126 may include, but are not limited to, cloud storage and analysis systems, big data analysis systems, manufacturing execution systems, data lakes, reporting systems, etc. In some scenarios, applications running at these higher levels of the enterprise may be configured to analyze control system operational data, and the results of this analysis may be fed back to an operator at the control system or directly to a controller 118 or device 120 in the control system.

Maintenance and troubleshooting of a plant's industrial control systems and their associated machines and devices are typically carried out by on-site service engineers or machine operators. While some types of routine machine alarm or fault conditions can be easily addressed, unfamiliar alarm conditions or system performance issues require the service personnel to expend considerable time and effort finding resolutions to the problems. These resolution efforts can include referencing device or software manuals or contacting a vendor's customer support personnel for assistance in diagnosing and resolving the condition.

To address at least some of these or other issues, one or more embodiments described herein provide an industrial technical support system that acts as an interactive assistant. The technical support system leverages generative artificial intelligence (AI) techniques to suggest solutions to industrial alarm conditions or other performance problems based on earlier documented solutions, thereby expediting the process of finding alarm resolutions. The system enhances a user's prompt with relevant contextual data retrieved from industry-trained custom models as well as relevant past chat histories in recommending accurate resolutions to alarm conditions or performance issues described by the user's prompt.

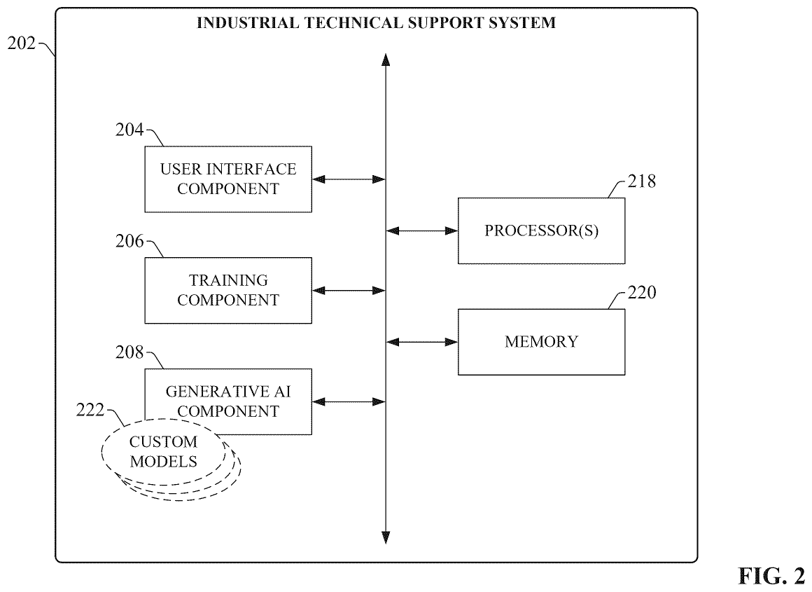

FIG. 2 is a block diagram of an example industrial technical support system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Industrial technical support system 202 can include a user interface component 204, a training component 206, a generative AI component 208, one or more processors 218, and memory 220. In various embodiments, one or more of the user interface component 204, training component 206, generative AI component 208, the one or more processors 218, and memory 220 can be electrically and/or communicatively coupled to one another to perform one or more of the functions of the industrial technical support system 202. In some embodiments, components 204, 206, and 208 can comprise software instructions stored on memory 220 and executed by processor(s) 218. Industrial technical support system 202 may also interact with other hardware and/or software components not depicted in FIG. 2. For example, processor(s) 218 may interact with one or more external user interface devices, such as a keyboard, a mouse, a display monitor, a touchscreen, or other such interface devices.

User interface component 204 can be configured to receive user input and to render output to the user in any suitable format (e.g., visual, audio, tactile, etc.). In some embodiments, user interface component 204 can be configured to generate and serve interface displays to a client device (e.g., a laptop computer, tablet computer, smart phone, etc.) that remotely accesses the technical support system 202 (e.g., via a hardwired or wireless connection). The user interface component 204 can then receive user input data and render output data via the client device. Input data that can be received via various embodiments of user interface component 204 can include, but is not limited to, natural language prompts or queries requesting assistance with an automation system alarm or performance conditions. Output data rendered by various embodiments of user interface component 204 can include natural language responses to user prompts as part of a chat-based technical support interaction.

Training component 206 can be configured to train one or more custom models 222 or knowledgebases with various types of relevant training data, including but not limited to industrial product documentation and archived histories of previous problem resolutions. These trained models are used by the system 202 in connection with processing a user's natural language queries or requests for technical support and generating suitable prompts to a generative AI model as needed to assist with generating natural language responses to these queries.

Generative AI component 208 can be configured to generate natural language responses to a user's technical support queries and requests using generative AI as needed. To this end, the generative AI component 208 can implement prompt engineering functionality using associated custom models 222 trained with domain-specific industrial training data. The generative AI component 208 can generate and submit prompts or meta-prompts to one or more generative AI models and associated neural networks, where these prompts are generated based on natural language requests or queries submitted by the user as well as domain-specific information contained in the custom models 222. Depending on the nature of the user's request or query, the responses returned by the generative AI model in response to the prompts can be used by the generative AI component 208 or the user interface component 204 to render answers to the user's technical support questions, example industrial device configuration settings predicted to solve a configuration or performance problem reported by the user, example maintenance actions predicted to address a reported industrial asset performance issue, or other such technical support recommendations.

The one or more processors 218 can perform one or more of the functions described herein with reference to the systems and/or methods disclosed. Memory 220 can be a computer-readable storage medium storing computer-executable instructions and/or information for performing the functions described herein with reference to the systems and/or methods disclosed.

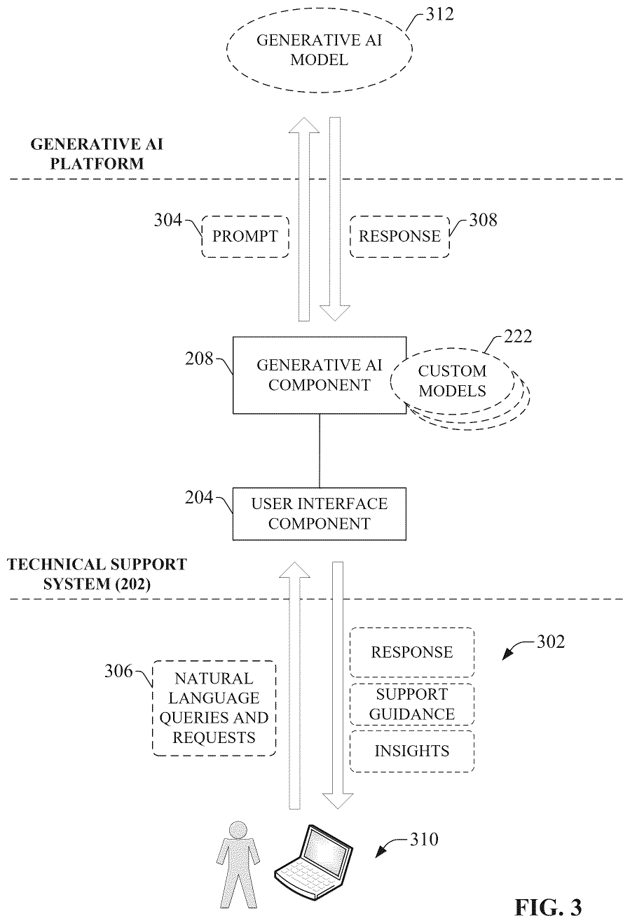

FIG. 3 is a diagram illustrating an example architecture of the industrial technical support system 202. Some embodiments of the technical support system 202 can be implemented on a cloud platform, as part of an Internet-of-Things (IoT) system, or on another centralized platform and made accessible to multiple industrial customers having authorized access to use the technical support system 202. Alternatively, some embodiments of technical support system 202 may execute at least partially on a local client device while accessing remote services and repositories as needed.

A client device 310 (e.g., a laptop computer, a tablet computer, a desktop computer, a mobile device, an HMI terminal, a wearable AR/VR appliance, etc.) owned by a user with suitable authentication credentials can access the system's support services. In some embodiments, the technical support system 202 can be an integrated sub-system of a larger industrial monitoring, analytics, or reporting system that monitors industrial assets and manufacturing operations at multiple customer sites and provides real-time alerts or reports to those customers based on this operations tracking. Alternatively, the technical support system 202 may be implemented as a standalone system for providing interactive support assistance to industrial customers.

Technical support system 202 leverages generative AI technologies in connection with providing technical support guidance for addressing alarm conditions or performance issues observed on a customer's industrial machines, assets, or automation systems. To this end, system 202 includes a generative AI component 208 that processes a user's natural language queries 306 and formulates responses 302 describing technical support guidance or suggestions based on analysis of the queries 306 together with relevant content of custom models 222 trained with domain-specific industrial training data. Additionally, as part of this analysis, the generative AI component 208 can, as needed, formulate and submit prompts 304 to a generative AI model 312, where these prompts 304 are designed to obtain responses 308 that assist the generative AI component 208 in determining the nature of the technical support issue described by the user's natural language query or request, determining technical support actions or recommendations for mitigating or addressing the issue, and formulating natural language responses 302 describing these recommended actions. In various embodiments, the generative AI model 312 can be any of a diffusion model, a variational autoencoder (VAE), a generative adversarial network (GAN), a language-based generative model such as a large language model (LLM), a generative pre-trained transformer (GPT), a long short-term memory (LSTM) network, or other such models. The generative AI component 208 can implement prompt engineering functionalities using the associated custom models 222, and can interface with the generative AI model 312 and associated neural networks to assist in identifying asset performance issues described by the user's queries 306 and formulating suitable natural language recommendations for addressing these issues.

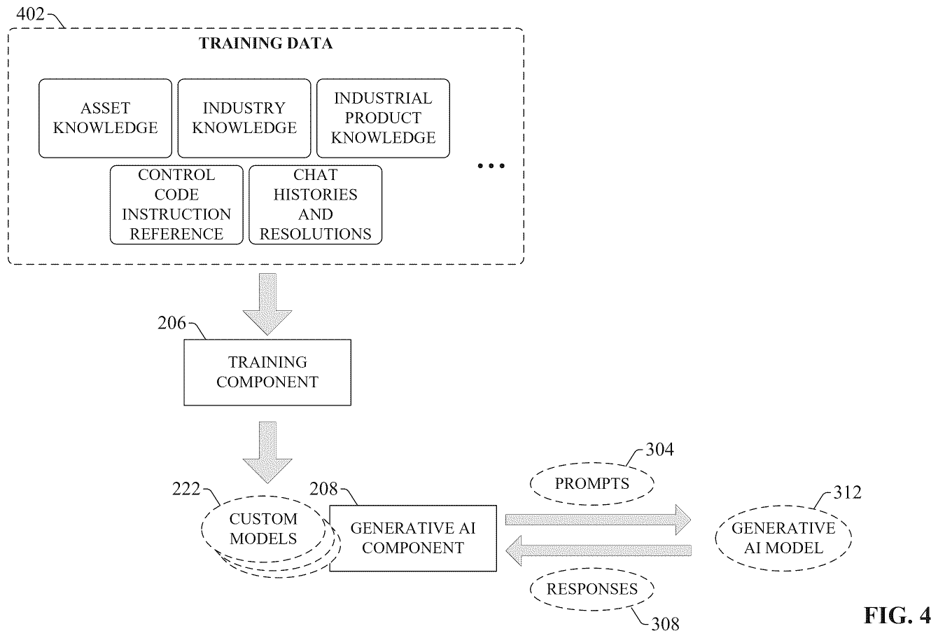

FIG. 4 is a diagram illustrating training of the custom models 222 used by the generative AI component 210. In some embodiments, the generative AI model 312 can reside and execute externally from the technical support system 202, and the generative AI component 208 can include suitable connectivity tools and protocols, application programming interfaces (APIs), or other such services that allow the generative AI component 208 to exchange prompts and responses with the generative AI model 312. The system's training component 214 can train the custom models 222 using sets of training data 402 representing a range of domain-specific industrial knowledge. Example training data 402 that can be used to train the custom models 222 includes, but is not limited to, libraries of product manuals for various types of industrial devices, assets, machines, or software platforms (including vendor-specific device manuals); help files; vendor knowledgebases; training materials; information defining industrial standards (e.g., global or vertical-specific safety standards, food and drug standards, design standards such as the ISA-88 standard, etc.); technical specifics or design standards for various types of industrial control applications (e.g., batch control processes, die casting, valve control, agitator control, etc.); knowledge of specific industrial verticals; knowledge of industrial best practices; histories of prior chat sessions with the technical support system 202 relating to specific technical support issues and their resolutions; and other such training data. Although FIG. 4 depicts the use of trained custom models 222, the training data 402 can alternatively be stored in a knowledgebase for access by the generative AI component 208 in some embodiments.

Archived chat histories, which can be stored by the system 202 and used to train the custom models 222 (or otherwise made accessible to the generative AI component 208), can comprise the content of chat sessions between the technical support system 202 and various users across multiple different customer entities. Each chat history can include the natural language queries 306 submitted by the user during a support session, as well as the support guidance, information, or resolution recommendations generated by the generative AI component 208 in response to these queries 306. In some embodiments, each chat history can also record feedback that was provided by the user indicating a degree to which system's responses addressed the concern specified by the initial query 306. This information can be leveraged by the generative AI component 208 in connection with formulating responses to subsequent queries 306 determined to be similar to the archived query.

As part of the analysis and processing of a user's natural language query 306, the generative AI component 210 can, as needed, formulate and submit prompts 304 to the generative AI model 312 designed to obtain responses 308 that assist the generative AI component 208 in ascertaining details of the technical issue to which the user's query 306 is directed and generating suitable technical support recommendations for addressing the issue. The generative AI component 208 can generate these prompts 304 based on content of the user's natural language query 306 as well as the industry knowledge and reference data encoded in the trained custom models 222. The generative AI component 210 can reference custom models 222 as needed in connection with processing a user's natural language queries 306 and prompting the generative AI model 312 for responses 308 that assist the generative AI component 208 in addressing the queries 306. Prompts 404 generated and submitted by the generative AI component 208 can include any information that assists the generative AI model 312 in converging on a useful response 406 that can be used to formulate technical support recommendations for accurately addressing the user's query 306, including but not limited to an identity, name, or description of the industrial asset or device that is the subject of the user's query 306 (e.g., a name or type of machine or industrial device), an indication of the type of industrial process or application being carried out by the industrial asset of interest (e.g., a specific type of batch processing, a specific automotive manufacturing function, a sheet metal stamping application, etc.), any selected subsets of the training data 402 determined to be relevant to the user's query 306, or other such data.

Returning to FIG. 3, through interaction with technical support interfaces generated by the system's user interface component 204, users can submit technical support queries 306 in the form of natural language inputs. To facilitate receipt of such queries 306, the user interface component 204 can render, on a user's client device 310, a chat interface for receiving typed or spoken-word natural language queries 306. In general, these queries 306 can specify, using natural language descriptions (e.g., natural language text or spoken input), the nature of the technical problem for which the user requires assistance. Users can compose natural language queries 306 that request assistance with observed runtime problems, design problems encountered during the design and development of industrial control systems, or devising maintenance strategies for prolonging the lifespan or optimizing performance of industrial assets. Example queries 306 can describe, for example, a performance issue observed on an industrial machine, device, or asset (e.g., an industrial device such as an industrial controller or motor drive, a machine that is part of an automation system, etc.); an error code being generated by an industrial device; a design problem for which assistance is requested (e.g., a request for recommended control code for performing a desired control function, a request for recommended device configuration settings that will configure an industrial device to operate in a desired manner within the context of a specified industrial control application, etc.), or other such relevant information. These queries 306 may include such information as a description or name of an alarm that was generated by a machine, device, or automation system (e.g., “Suggest remedy for high syslog memory alarm,” “Seeing error code: 5000 what do I need to do to fix it?”, etc.); an identity of an industrial device, asset, or system for which support is needed together with a description of the type of assistance required (e.g., “How do I replace the fan on my 755 drive?”, “What is the repair time for my motor drive?”, “What maintenance do I need to do for the MV6000 drive that I have had for about 4 years?”, etc.); or other information describing the type of desired support assistance.

The technical support system 202 can consider any of the information from the custom models 222 or their associated training data 402 (e.g., technical information about industrial assets, past chat histories, etc.) as well as prompted responses 406 from the generative AI model 312 in connection with formulating technical support recommendations for addressing an issue described by the user's natural language query 306.

Depending on the content of the user's initial query 306, the generative AI component 208 may determine that the query 306 does not contain sufficient information for providing high-confidence technical support guidance, or that additional information from the user about the problem being observed would yield technical support guidance having a higher probability of satisfying the user's query 306 (e.g., a probability of accurately addressing the user's query 306 that exceeds a defined threshold probability). In such cases, the generative AI component 208 can render, via the user interface component 204, a natural language request for additional information from the user that can be used to refine the user's initial technical support query 306 prior generating a full response 302 to the user's original query 306. As part of this process, the generative AI component 208 can prompt the user for specific items of additional information that will refine or enhance the initial query 306 in a manner that improves the likelihood that the generative AI component 208 will generate an accurate technical support response that satisfies the user's query. In this way, the generative AI component 208 can carry out an iterative natural language dialogue with the user, prompting the user to provide sufficient details about the technical support issue to ensure that the system 202 provides highly reliable and accurate technical support guidance.

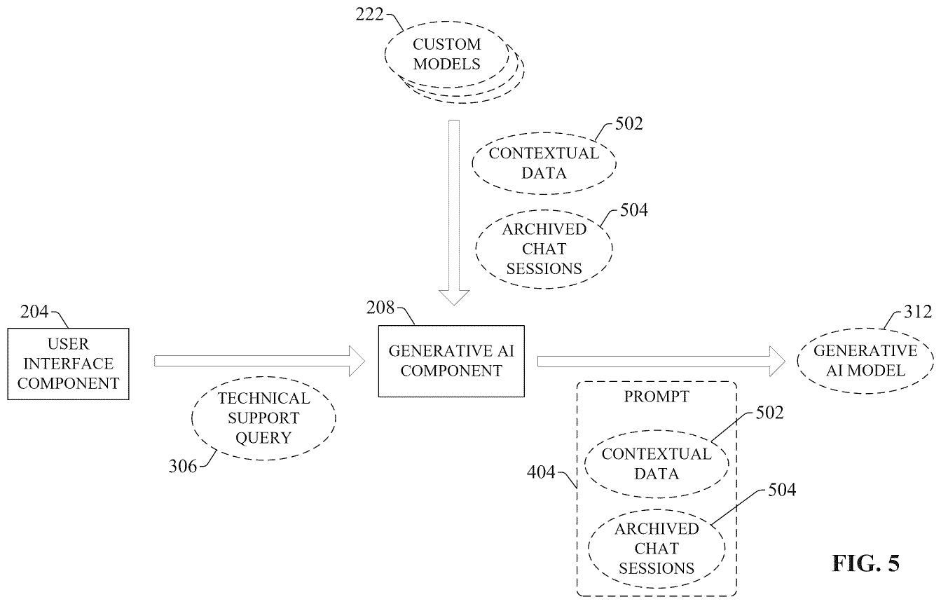

FIG. 5 is a diagram illustrating creation and submission of a prompt 404 to the generative AI model 312 in response to receipt of a natural language technical support query 306 from a user. When a query 306 requesting technical support assistance is received from a user associated with a customer entity (e.g., “Suggest remedy for high syslog memory alarm”), the generative AI component 208 analyzes the content of the query 306 and retrieves, as contextual data 502, a subset of the training data 402 from the custom models 222 determined to be relevant to the query 306. This contextual data 502 can include, for example, portions of technical manuals for an industrial device or asset that is the subject of the query 306, relevant knowledgebase information about the asset or about a type of industrial application to which the query 306 is directed, or other such information. The selected subset of training data 402 can depend on such factors as the devices, machines, or industrial assets identified in the user's query 306 (which may guide selection of information from corresponding product manuals or knowledgebase articles stored as part of the training data 402); the nature of the technical support request conveyed by the query 306; an identity of a specific alarm for which assistance is requested; or other such factors.

Additionally, the generative AI component 208 can identify any archived chat sessions 504 from among the archived chat histories that were directed to a customer support issue determined to be similar to the issue described by the query 306 currently being processed, and retrieve these similar chat sessions 504 to include as part of the analysis. These similar chat histories can include information regarding how technical support issues similar to that described in the query 306 were resolved in the past, as well as metrics regarding how well the resolutions proposed by the system 202 satisfied the users' issues (e.g., in the form of user feedback or ratings).

In some embodiments, each registered customer entity can be assigned a customer-specific repository in which the customer can store their own proprietary documentation and custom models 222. This proprietary documentation and the customer-specific custom models 222 can be used by the technical support system 202 to customize the generative AI component's responses 302 in accordance with the customer's proprietary equipment, standards, protocols, or preferences. Accordingly, when a query 306 is received from a user associated with a customer entity, the generative AI component 208 can retrieve relevant contextual data 502 and chat sessions 504 from one or both of the customer-agnostic custom models 222 and the customer-specific documentation and models 222 associated with that customer entity.

Based on analysis of the user's query 306, the relevant industry knowledge encoded in the contextual data 502, and the relevant archived chat sessions 504, the generative AI component 208 may formulate and return a response 302 to the user's query 306 without accessing the generative AI model 312. The generative AI component 208 can also, as needed, prompt the generative AI model 312 for responses 308 that can assist in generating suitable responses to the user's query 306. For example, in response to receipt of a query 306, the generative AI component 208 can determine whether a sufficiently accurate response 302 to the query 306 can be generated based on relevant information contained in the custom models 222 alone, or, alternatively, whether supplemental information from the generative AI model 312 is necessary to formulate a response 302 having a sufficiently high probability of addressing the technical support issue described by the user's query 306. If supplemental information from the generative AI model 312 is deemed necessary (e.g., the generative AI component 208 determines that additional information from the generative AI model 312 would allow the generative AI component 208 to formulate a response 302 having a higher probability of satisfying the user's initial query 306, or having a probability of satisfying the query 306 that exceeds a defined threshold), the generative AI component 208 can formulate a prompt 404 based on analysis of the query 306 and the industrial knowledge encoded in the custom models 222. These prompts 404 are designed to obtain responses 406 from the generative AI model 312 that can be used by the generative AI component 208 to formulate accurate and cohesive responses 302 to the user's query 306. The generative AI component 208 can include, in the prompt 304, any information that can assist the generative AI model 312 in converging on a response 406 useful for formulating suitable guidance that addresses the user's query 306, including but not limited to information extracted or inferred from the user's query 306 (e.g., an identify of the affected industrial asset, an identity of the technical issue being experienced, a type of industrial application being performed by the industrial asset, an industrial vertical in which the asset operates, etc.) and any portion of the relevant contextual data 502 or archived chat sessions 504 retrieved from the custom models 222.

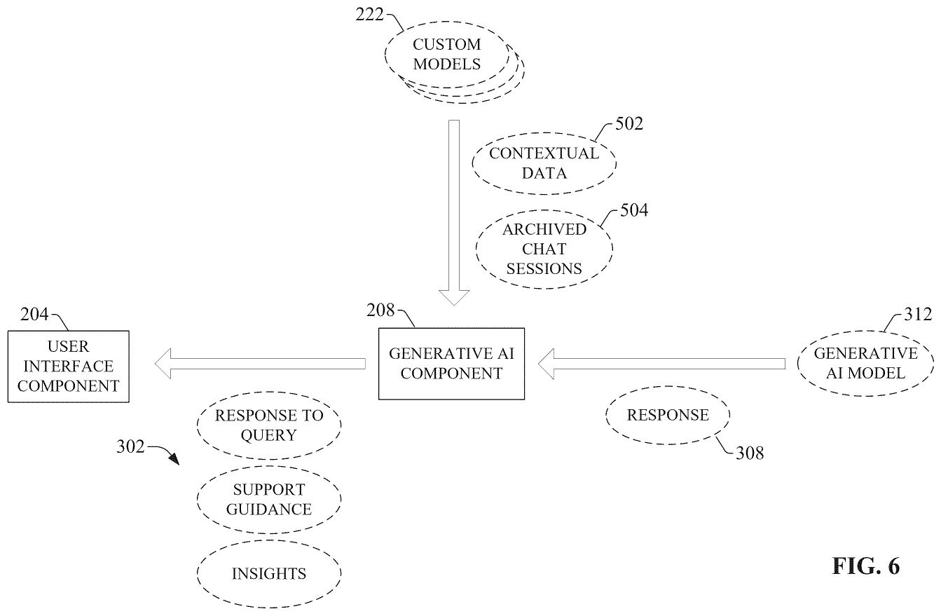

FIG. 6 is a diagram illustrating formulation and delivery of a response 302 to the user's natural language query 306 by the generative AI component 208 using the information gathered as described above. Once the generative AI component 208 has obtained the information discussed above, the generative AI component 208 analyzes the user's original query 306 (as well as any subsequent information prompted from the user by the generative AI component 208), relevant contextual data 502, similar chat sessions 504, and, if appropriate, a response 308 generated by the generative AI model 312, and formulates a natural language response 302 to the query 306 based on a result of this analysis. The user interface component 204 can then render this response 302 on the user's client device 310. The nature of the response 302 depends on the type of support being requested by the query 306. For example, if the query 306 requests assistance in addressing an alarm condition on an industrial asset, the response 302 can provide a natural language explanation of the alarm together with suggested actions or steps that can be performed to correct the alarm condition. If the query 306 comprises a question about an industrial device or asset (e.g., a question regarding how to perform a specified maintenance operation on the asset, a query about an estimated amount of time required to perform the maintenance operation, a request for suggested preventative maintenance actions to be performed on the asset in order to improve a performance metric or extend the assets lifecycle, etc.), the response 302 can comprise a natural language answer to the user's question.

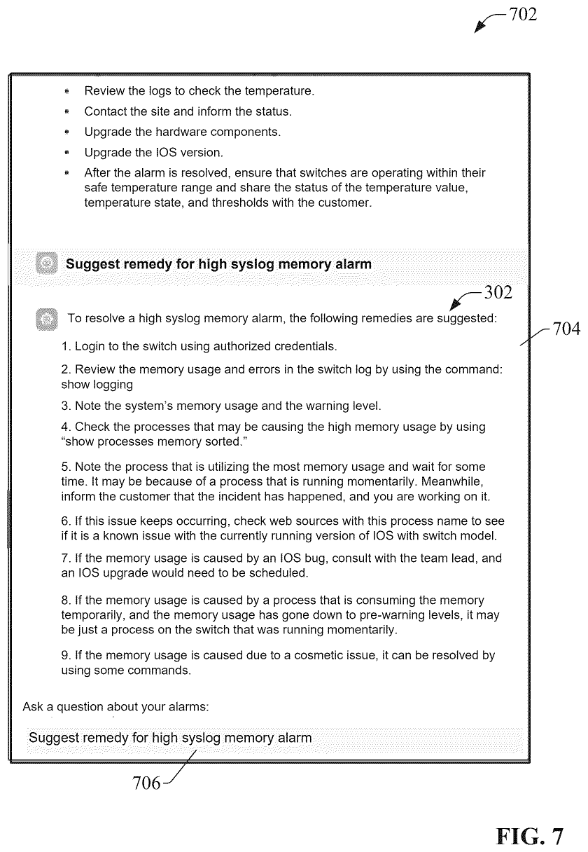

FIG. 7 is an example chatbot window 702 that can be generated by the user interface component 204 and used to interact with the technical support system 202. The example chatbot window 702 includes a data entry field 506 through which a user can submit the natural language technical support queries 306 to the system 202. In the illustrated example, the user has submitted a query 306 requesting a remedy for a specified alarm that the user has observed on an industrial asset (“Suggest remedy for high syslog memory alarm.”). In response to submission of this query 306, the generative AI component 208 processes the query 306 as described above in connection with FIGS. 3-6 and generates its response 302 based on this processing. The user interface component 204 renders the response 302 in a response section 704 of the chatbot window 702. In the illustrated example, the response 302 is in the form of a numbered and ordered list of steps to be performed in order to remedy the indicated alarm. As described above, the generative AI component 208 can, as needed, generate and render natural language follow-up prompts to the user requesting additional information with which to supplement the original query 306, if it is determined that this additional information would yield a response 302 having a sufficient level of probability of accurately addressing the user's query 306.

In some embodiments, the user interface component 204 can enforce various constraints on a user's interaction with the technical support system 202 via the chatbot window 702 (or another interface through which the user exchanges natural language dialogs with the system 202). This can include managing user logins and user authentications, as well as enforcing rules, filters, or guardrails that constrain the syntax or format of the user's natural language queries 306 to ensure that the queries 306 can be correctly understood by the generative AI component 208 and are formatted in a manner that assists the generative AI component 208 in converging on accurate solutions to the issue described by the queries 306.

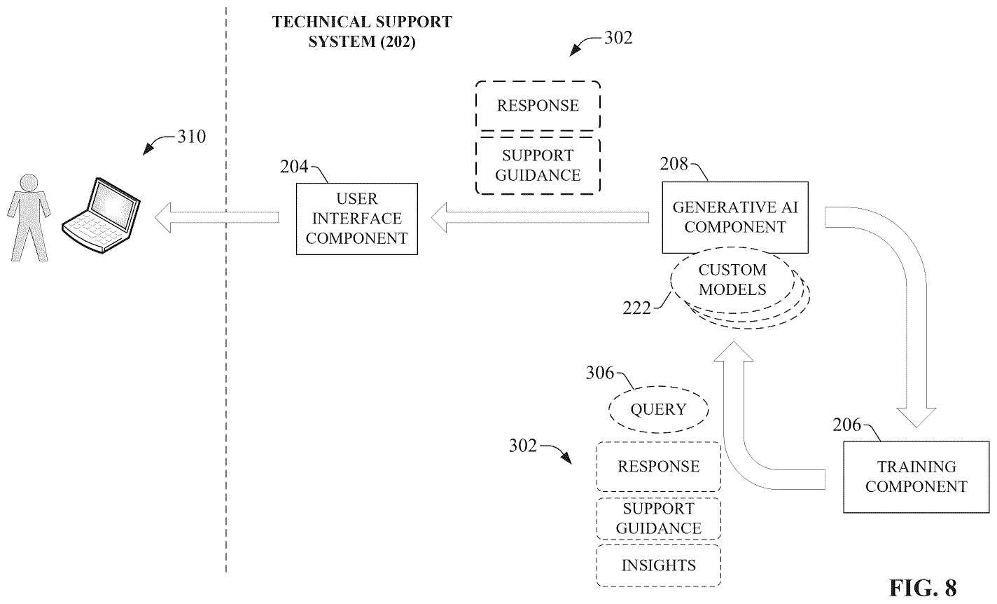

FIG. 8 is a diagram illustrating delivery of the technical support system's response 302 and updating of the custom models 222. When the generative AI component 208 has generated a response 302 to a user's query 306 as described above, the response 302 is submitted to the user interface component 204 for rendering on the user's client device 310 (e.g., via chatbot window 702 illustrated in FIG. 7 or another suitable chatbot interface). Additionally, the user's query 306 is stored in association with the generative AI component's responses 302 to the query 306, making the query 306 and responses 302 accessible to the generative AI component 208 for use in refining future responses 302 to similar prompts 306. In some embodiments, the query 306 and corresponding response 302 can be provided to the training component 206, which updates the custom models' training using the query 306 and response 302. If the user has provided feedback indicating a degree to which the system's response 302 addressed the user's issue, the training component 206 can also store this feedback information in association with the query 306 and corresponding responses 302 in the custom models 222.

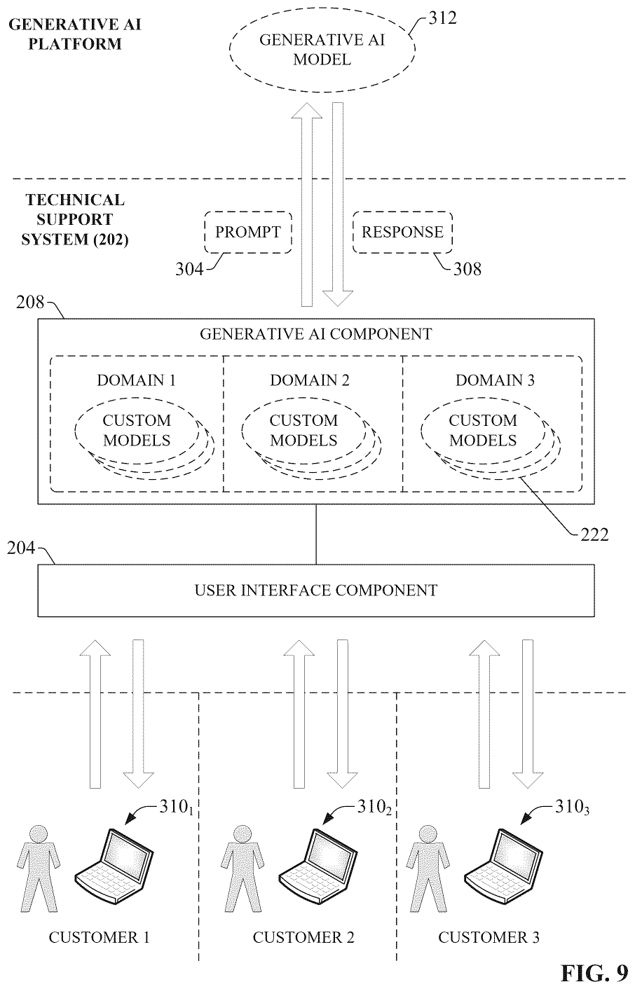

In some embodiments, the architecture of the technical support system 202 can support segregation of custom models 222 and associated prompt training according to different industrial domains. FIG. 9 is a diagram illustrating an example architecture in which the technical support system maintains separate sets of custom models 222 associated with respective different industrial domains. In this example, the generative AI component 208 maintains multiple sets of custom models 222 associated with respective different industrial domains or verticals (e.g., food and beverage, pharmaceutical, automotive, textiles, mining, oil and gas, power generation, semiconductors, life sciences, etc.). Each domain-specific set of custom models 222 is trained using a set of training data 402 specific to the associated industrial domain. The domain-specific training data 402 for a given industrial domain can include, for example, safety or design standards that are specific to the industrial domain (including statutory standards and regulations that govern industrial operations and quality controls for a given domain), technical support chat histories that are specific to problems commonly encountered within the industrial domain, terminology used within the industrial domain, product documentation for devices or machines commonly used within the domain, or other such data.

Customer entities can be registered with the technical support system 202 according to the industrial domains or verticals in which those entities operate. When the system technical support system 202 receives a query 306 from a user associated with a registered customer entity, the generative AI component 208 processes the query 306, as described above, using the set of custom models 222 corresponding to the domain in which the customer entity operates. In addition to, or as an alternative to, selecting the appropriate set of domain-specific custom models 222 corresponding to the user's registered domain, the generative AI component 208 can determine or infer the domain to which the user's query 306 pertains, and process the query 306 using the set of custom models 222 corresponding to the inferred domain. The use of segregated domain-specific custom models 222, each trained using domain-specific training data 402, can allow the system 202 to provide technical support responses 302 to domain-specific queries 306 that more closely catered to the idiosyncrasies of different industrial domains, while reducing instances of less relevant technical support responses 302 that may not be applicable to a user's domain of interest.

The industrial technical support system 202 described herein can expedite the process of resolving asset performance issues or alarm conditions by leveraging generative AI together with selected prompt engineering training data determined to be relevant to the issue being addressed. The system 202 can maintain custom models trained with domain-specific industrial knowledge, which together with responses prompted from a generative AI model allows the system to provide targeted technical support guidance having a high probability of addressing user's technical support queries.

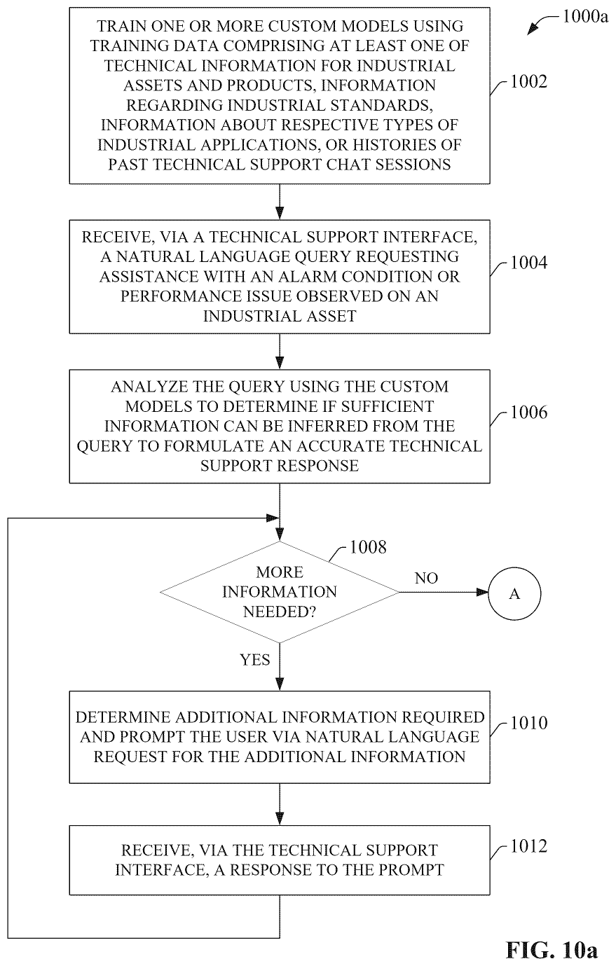

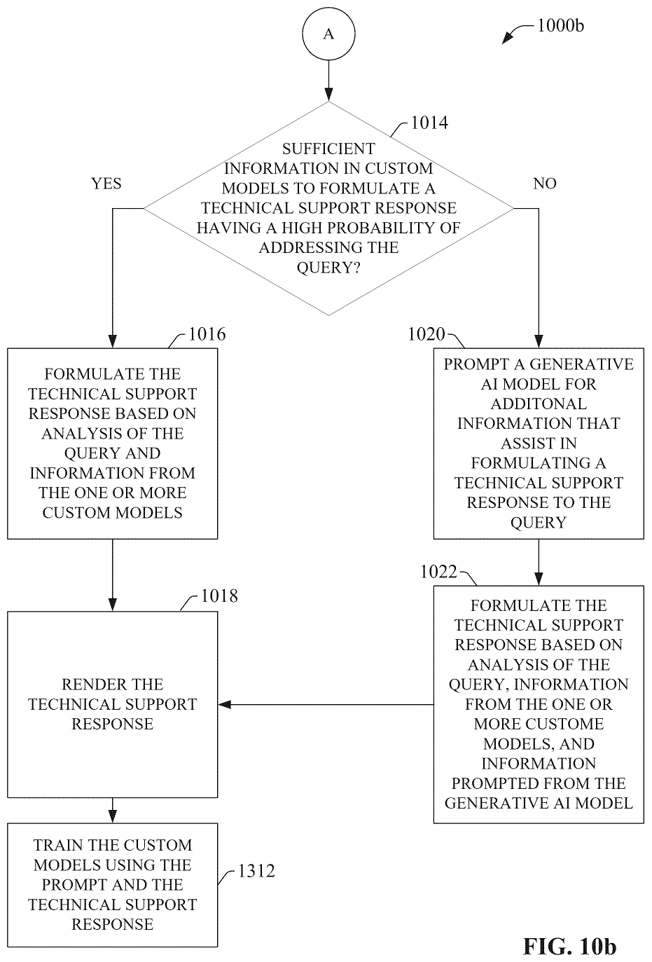

FIGS. 10a-10b illustrate a methodology in accordance with one or more embodiments of the subject application. While, for purposes of simplicity of explanation, the methodology shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 10a illustrates a first part of an example methodology 1000a for using generative AI to provide technical guidance for resolving automation system performance problems or alarm conditions observed on industrial assets. Initially, at 1002, one or more custom models are trained using training data comprising at least one of libraries of product manuals for various types of industrial devices, assets, machines, or software platforms, help files, vendor knowledgebases, training materials, information defining industrial standards (e.g., global or vertical-specific safety standards, food and drug standards, design standards such as the ISA-88 standard, etc.), technical specifics or design standards for various types of industrial control applications, knowledge of specific industrial verticals, knowledge of industrial best practices, histories of prior chat sessions with the technical support system relating to specific technical support issues and their resolutions, or other such domain-specific training data.

At 1004, a natural language query is received via a technical support interface, where the query requests assistance with a performance issue observed on an industrial asset or with an industrial control design problem. The query can be submitted in substantially any type of natural language format, including typed text or spoken word input, and can describe the nature of the technical problem for which the user requires assistance. Example natural language queries can describe, for example, a performance issue observed on an industrial machine, device, or asset; an error code being generated by an industrial device; a design problem for which assistance is requested, or other such relevant information. The query can include such information as a description or name of an alarm that was generated by a machine, device, or automation system; an identity of an industrial device, asset, or system for which support is needed together with a description of the type of assistance required; or other information describing the type of desired support assistance.

At 1006, the query received at step 1004 is analyzed using the custom models trained at step 1002 to determine if sufficient information can be inferred from the query to formulate a technical support response having a sufficiently high probability of accurately addressing the concern represented by the query. At 1008, a determination is made as to whether more information is needed from the user in order to generate an accurate technical support response satisfying the user's query. If additional information is required (YES at step 1008), the methodology proceeds to step 1010, where the system determines the additional information required, and renders a natural language prompt designed to guide the user toward providing the additional information. In determining the nature of the necessary additional information, the system can reference the industry knowledge encoded in the custom models as well as responses prompted from a generative AI model. At 1012, a response to the prompt generated at step 1010 is received via the technical support interface.

Steps 1008-1012 are repeated as a natural language dialog with the user until sufficient information translatable to an accurate technical support response has been obtained. When no further information is required from the user (NO at step 1008), the methodology proceeds to the second part 1000b illustrated in FIG. 10b. At 1014, a determination is made as to whether the custom models contain sufficient information to formulate a technical support response having a high probability of addressing the query received at step 1004. If sufficient information is contained in the custom models (YES at step 1014), the methodology proceeds to step 1016, where a natural language technical support response predicted to address the user's query is formulated based on analysis of the original query, any additional information received from the user at step 1012, and relevant information from the one or more custom models. At 1018, the technical support response is rendered on the technical support interface.

Alternatively, if the information contained in the custom models is not sufficient for formulating a technical support response predicted to have a high probability of addressing the query (NO at step 1014), the methodology proceeds to step 1020, where a generative AI model is prompted for additional information that can assist in formulating a technical support response to the query predicted to have a high probability of addressing the concern described by the query. In this regard, the system can generate a suitable prompt directed to the generative AI model and designed to obtain relevant information or guidelines that can assist the system in formulating a suggestion for addressing the technical problem represented by the query. This prompt can contain any relevant information that can assist in yielding relevant technical support suggestions, including but not limited to an identity, name, type, or description of the industrial asset experiencing the risk. At 1022, a technical support response is generated based on analysis of the user's query, additional information obtained from the user at step 1012, relevant information from the custom models, and the additional information prompted from the generative AI model at step 1020. The methodology then proceeds to step 1018, where the technical support response is rendered on the technical support interface.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors-electronic integrated circuits that perform logic operations employing electric signals-configured to execute instructions stored in media such as random access memory (RAM), read only memory (ROM), a hard drives, as well as removable memory devices, which can include memory sticks, memory cards, flash drives, external hard drives, and so on.

Similarly, the term PLC (programmable logic controller) or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

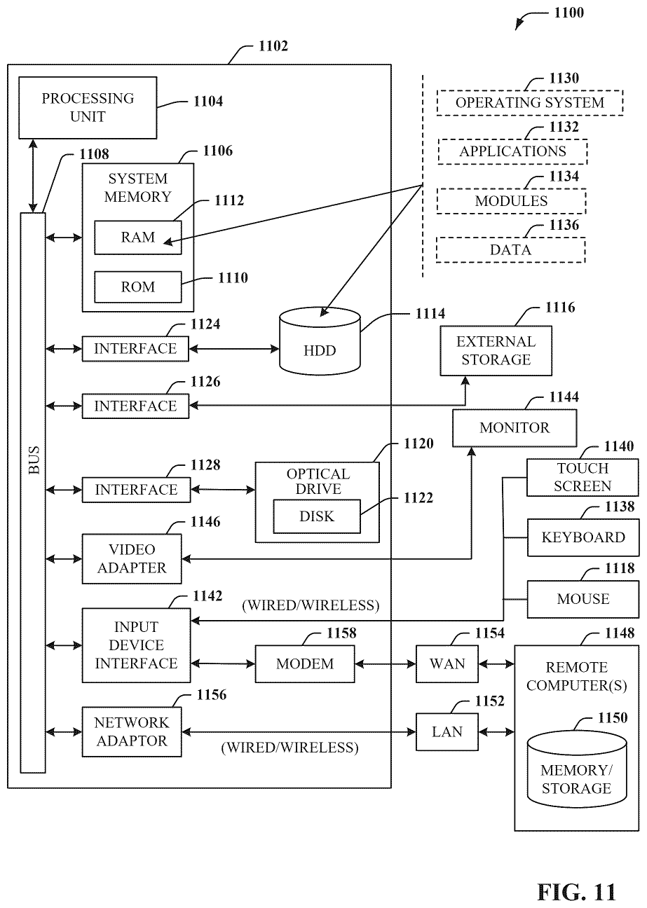

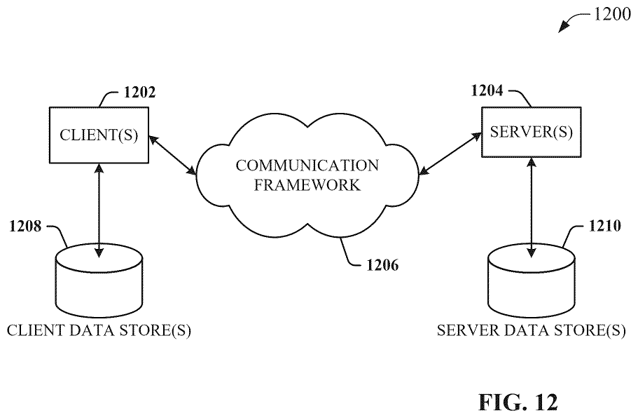

In order to provide a context for the various aspects of the disclosed subject matter, FIGS. 11 and 12 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for application programs 1132. Runtime environments are consistent execution environments that allow application programs 1132 to run on any operating system that includes the runtime environment. Similarly, operating system 1130 can support containers, and application programs 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1118. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1144 or other type of display device can be also connected to the system bus 1108 via an interface, such as a video adapter 1146. In addition to the monitor 1144, a computer typically includes other peripheral output devices (not shown), such as speakers, printers, etc.

The computer 1102 can operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1152 through a wired and/or wireless communication network interface or adapter 1156. The adapter 1156 can facilitate wired or wireless communication to the LAN 1152, which can also include a wireless access point (AP) disposed thereon for communicating with the adapter 1156 in a wireless mode.

When used in a WAN networking environment, the computer 1102 can include a modem 1158 or can be connected to a communications server on the WAN 1154 via other means for establishing communications over the WAN 1154, such as by way of the Internet. The modem 1158, which can be internal or external and a wired or wireless device, can be connected to the system bus 1108 via the input device interface 1142. In a networked environment, program modules depicted relative to the computer 1102 or portions thereof, can be stored in the remote memory/storage device 1150. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1152 or WAN 1154 e.g., by the adapter 1156 or modem 1158, respectively. Upon connecting the computer 1102 to an associated cloud storage system, the external storage interface 1126 can, with the aid of the adapter 1156 and/or modem 1158, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 12 is a schematic block diagram of a sample computing environment 1200 with which the disclosed subject matter can interact. The sample computing environment 1200 includes one or more client(s) 1202. The client(s) 1202 can be hardware and/or software (e.g., threads, processes, computing devices). The sample computing environment 1200 also includes one or more server(s) 1204. The server(s) 1204 can also be hardware and/or software (e.g., threads, processes, computing devices). The servers 1204 can house threads to perform transformations by employing one or more embodiments as described herein, for example. One possible communication between a client 1202 and servers 1204 can be in the form of a data packet adapted to be transmitted between two or more computer processes. The sample computing environment 1200 includes a communication framework 1206 that can be employed to facilitate communications between the client(s) 1202 and the server(s) 1204. The client(s) 1202 are operably connected to one or more client data store(s) 1208 that can be employed to store information local to the client(s) 1202. Similarly, the server(s) 1204 are operably connected to one or more server data store(s) 1210 that can be employed to store information local to the servers 1204.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components; and
a processor, operatively coupled to the memory, that executes the executable components, the executable components comprising:
a user interface component configured to receive, from a client device as natural language input, a query describing a performance issue relating to an industrial automation system for which technical support is requested; and
a generative artificial intelligence (AI) component configured to, in response to receipt of the query, formulate a prompt, directed to a generative AI model, designed to obtain a response from the generative AI model comprising information used by the generative AI component to generate a natural language technical support response describing a recommendation for addressing the performance issue, wherein the generative AI component generates the prompt based on analysis of the query and a selected subset of industrial training data encoded in one or more custom models,
wherein the user interface component is configured to render the natural language technical support response on the client device.

2. The system of claim 1, further comprising a training component configured to train the one or more custom models with the industrial training data, wherein the industrial training data comprises at least one of libraries of product manuals for different types of industrial devices or software platforms, help files, vendor knowledgebase data, information defining industrial standards, technical specifics for different types of industrial control applications, information describing specifics of different industrial verticals, information regarding industrial best practices, or archived technical support chat sessions with the system.

3. The system of claim 1, wherein the query comprises at least one of a description of observed behavior of a device or machine of the industrial automation system, a description of an error code or alarm observed on an industrial device, a request for example control code for performing a described control function, a request for recommended configuration settings for an industrial device that will cause the industrial device to operate in a described manner, a question regarding how to perform a specified maintenance task on a machine of the industrial automation system, a question regarding an estimated amount of time to perform a specified maintenance task, or a request for suggested maintenance actions to perform on a device or machine of the industrial automation system.

4. The system of claim 1, wherein
the industrial training data comprises at least archived technical support chat sessions comprising previous queries submitted to the system and corresponding technical support responses generated by the generative AI component, and the selected subset of the industrial training data comprises a subset of the archived technical support chat sessions determined to address a technical support issue similar to the performance issue described by the query.

5. The system of claim 1, further comprising a training component configured to train the one or more custom models using the query and the natural language technical support response.

6. The system of claim 1, wherein
the system stores multiple sets of domain-specific custom models, including the one or more custom models, that are trained with respective sets of domain-specific training data corresponding to respective different industrial domains, and
the generative AI component is configured to at least one of formulate the prompt or the natural language technical support response based on analysis of the query and the selected subset of the industrial training data encoded in a set of domain-specific custom models, of the multiple sets of domain-specific custom models, corresponding to an industrial domain to which the query pertains.

7. The system of claim 6, wherein the industrial domain is at least one of food and beverage, pharmaceutical, automotive, textiles, mining, oil and gas, power generation, semiconductors, or life sciences.

8. The system of claim 1, wherein the generative AI component is configured to formulate the prompt directed to the generative AI model in response to inferring that the response from the generative AI model will cause the natural language technical support response to have a probability of accurately addressing the performance issue described by the query that exceeds a probability threshold.

9. The system of claim 1, wherein the generative AI component is configured to formulate the prompt to include at least one of information extracted or inferred from the query, an identify of an industrial asset affected by the performance issue, a description of the performance issue being experienced, a type of industrial application being performed by the industrial automation system, an industrial vertical in which the industrial automation system operates, or the selected subset of the industrial training data.

10. A method, comprising:
receiving, by a system comprising a processor from a client device, a query formatted as a natural language input, wherein the query describes a performance issue relating to an industrial automation system for which technical support is requested;
in response to the receiving, formulating, by the system based on analysis of the query and a selected subset of industrial training data encoded in one or more custom models, a prompt directed to a generative artificial intelligence (AI) model, wherein the prompt is formulated to obtain a response from the generative AI model comprising information used by the system to generate a natural language technical support response describing a recommendation for addressing the performance issue; and
rendering, by the system, the natural language technical support response on the client device.

11. The method of claim 10, further comprising training, by the system, the one or more custom models with the industrial training data, wherein the industrial training data comprises at least one of libraries of product manuals for different types of industrial devices or software platforms, help files, vendor knowledgebase data, information defining industrial standards, technical specifics for different types of industrial control applications, information describing specifics of different industrial verticals, information regarding industrial best practices, or archived technical support chat sessions with the system.

12. The method of claim 10, wherein the query comprises at least one of a description of observed behavior of a device or machine of the industrial automation system, a description of an error code or alarm observed on an industrial device, a request for example control code for performing a described control function, a request for recommended configuration settings for an industrial device that will cause the industrial device to operate in a described manner, a question regarding how to perform a specified maintenance task on a machine of the industrial automation system, a question regarding an estimated amount of time to perform a specified maintenance task, or a request for suggested maintenance actions to perform on a device or machine of the industrial automation system.

13. The method of claim 10, wherein
the industrial training data comprises at least archived technical support chat data comprising previous queries submitted to the system and corresponding technical support responses generated by the system, and
the selected subset of the industrial training data comprises a subset of the archived technical support chat data determined to address a technical support issue similar to the performance issue described by the query.

14. The method of claim 10, further comprising training, by the system, the one or more custom models using the query and the natural language technical support response.

15. The method of claim 1, further comprising storing, by the system, multiple sets of domain-specific custom models, including the one or more custom models, that are trained with respective sets of domain-specific training data corresponding to respective different industrial domains,
wherein the formulating comprises formulating the prompt based on analysis of the query and the selected subset of the industrial training data encoded in a set of domain-specific custom models, of the multiple sets of domain-specific custom models, corresponding to an industrial domain to which the query pertains.

16. The method of claim 16, wherein the industrial domain is at least one of food and beverage, pharmaceutical, automotive, textiles, mining, oil and gas, power generation, semiconductors, or life sciences.

17. The method of claim 10, wherein the formulating comprises formulating the prompt in response to inferring that the response from the generative AI model will cause the natural language technical support response to have a probability of accurately addressing the performance issue described by the query that exceeds a probability threshold.

18. The method of claim 10, wherein the formulating comprises formulating the prompt to include at least one of information extracted or inferred from the query, an identify of an industrial asset affected by the performance issue, a description of the performance issue being experienced, a type of industrial application being performed by the industrial automation system, an industrial vertical in which the industrial automation system operates, or the selected subset of the industrial training data.

19. A non-transitory computer-readable medium having stored thereon instructions that, in response to execution, cause a system comprising a processor to perform operations, the operations comprising:
receiving, from a client device, a query formatted as a natural language input, wherein the query describes a performance issue relating to an industrial automation system for which technical support is requested;
in response to the receiving, formulating, based on analysis of the query and a selected subset of industrial training data encoded in one or more custom models, a prompt directed to a generative artificial intelligence (AI) model, wherein the prompt is formulated to obtain a response from the generative AI model comprising information used by the system to generate a natural language technical support response describing a recommendation for addressing the performance issue; and
rendering, by the system, the natural language technical support response on the client device.

20. The non-transitory computer-readable medium of claim 19, further comprising training, by the system, the one or more custom models with the industrial training data, wherein the industrial training data comprises at least one of libraries of product manuals for different types of industrial devices or software platforms, help files, vendor knowledgebase data, information defining industrial standards, technical specifics for different types of industrial control applications, information describing specifics of different industrial verticals, information regarding industrial best practices, or archived technical support chat sessions with the system.
